(19) United States
(12) Patent Application Publication
(10) Pub. No.: US 2009/0286538 A1
(43) Pub. Date: Nov. 19, 2009

(54) Method for digitally drawing numbers

(75) Inventor: Jan Wieghardt, Munich (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT

(21) Appl. No.: 12/453,596

(22) Filed: May 15, 2009

(30) Foreign Application Priority Data
May 16, 2008 (DE) 10 2008 023 917.8

(51) Int. Cl. H04W 4/00

(52) U.S. Cl. 455/435.1

(57) ABSTRACT

A method is disclosed for essentially making the drawing of numbers, for the organization of individuals who are waiting, significantly more flexible without loss of functionality. In at least one embodiment of the method, each of those waiting individuals registers themselves with a number-drawing server using a mobile telephone, specifying a unique identification number and a queuing destination. The mobile telephone of each of those waiting then communicates to the number-drawing server, at certain intervals, its current position and requests from the number-drawing server a current-status update. The number-drawing computer then determines from the waiting individuals current position whether this is geographically at such a distance that this individual has any possibility of meeting the next appointment time, and that if he is geographically too far away, others who are waiting are brought forward in the waiting queue.

### PRIORITY STATEMENT

The present application hereby claims priority under 35 U.S.C. §119 on German patent application number DE 10 2008 023 917.8 filed May 16, 2008, the entire contents of which is hereby incorporated herein by reference.

### FIELD

At least one embodiment of the invention generally relates to a method by which a position in a queue is determined by electronic device(s).

### BACKGROUND

Until now this problem has been dealt with, for example in official organizations, by drawing numbers at a central issuing point. The number designates a position in a queue, and the last number called is shown on a display.

### SUMMARY

In at least one embodiment of the invention a method is specified for digitally drawing numbers, by which the drawing of numbers is made significantly more flexible overall, without this involving any loss of functionality. A solution is required for the organization of waiting in hospitals, official organizations, administrative offices, etc. What is important here is that the waiting is organized in such a way that no doubts arise among those waiting as to their position in the queue, and also that the position cannot be altered by any initiative of those waiting, that all those currently waiting in the queue wish to make use of the services of the administrative office or official organization, and have not provisionally reserved several places, so that it is possible to ensure that all those involved can make plans and that those who are waiting are also present as soon as it is their turn.

At least one embodiment relates to a method according to the invention, computer programs for carrying out the method according to the invention for a mobile telephone and for a server, together with a server with such a computer program.

At least one embodiment of the invention resides essentially in making the drawing of numbers for the organization of individuals who are waiting significantly more flexible, without loss of functionality, in that each of those waiting registers themselves with a number-drawing server using a mobile telephone, specifying a unique identification number and a queuing destination, that the mobile telephone of each of those waiting communicates to the number-drawing server at certain intervals its current position and requests from the number-drawing server a current-status update, that the number-drawing server determines from the waiting individual's current position whether this is geographically at such a distance that this individual has any possibility of meeting the next appointment time, and that if he is geographically too far away others who are waiting are brought forward.

At least one embodiment of the invention combines location-specific and location independent services in such a way that physical proximity is only required for those process steps for which this is necessary from the point of view of the overall process. The number-drawing process per se requires geographical proximity to the destination location if the number of a waiting individual is drawn, whereby the spatial proximity will be evidence of an interest, or increases the probability, that the registered user will also really appear for his appointment. As an option, the condition of initial proximity as an expression of interest could also use a system of deposits. Physical proximity then only becomes relevant again if the waiting individual is to be called; the nearer he then is to the destination, the higher is the probability that he will also really appear for the actual appointment.

### BRIEF DESCRIPTION OF THE DRAWINGS

The invention is explained below in more detail by reference to an example embodiment illustrated in the drawings, in which;

FIG. 1 a scenario for illustrating the registration,

FIG. 2 a scenario for illustrating the status information, and

FIG. 3 a scenario for illustrating the position update.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

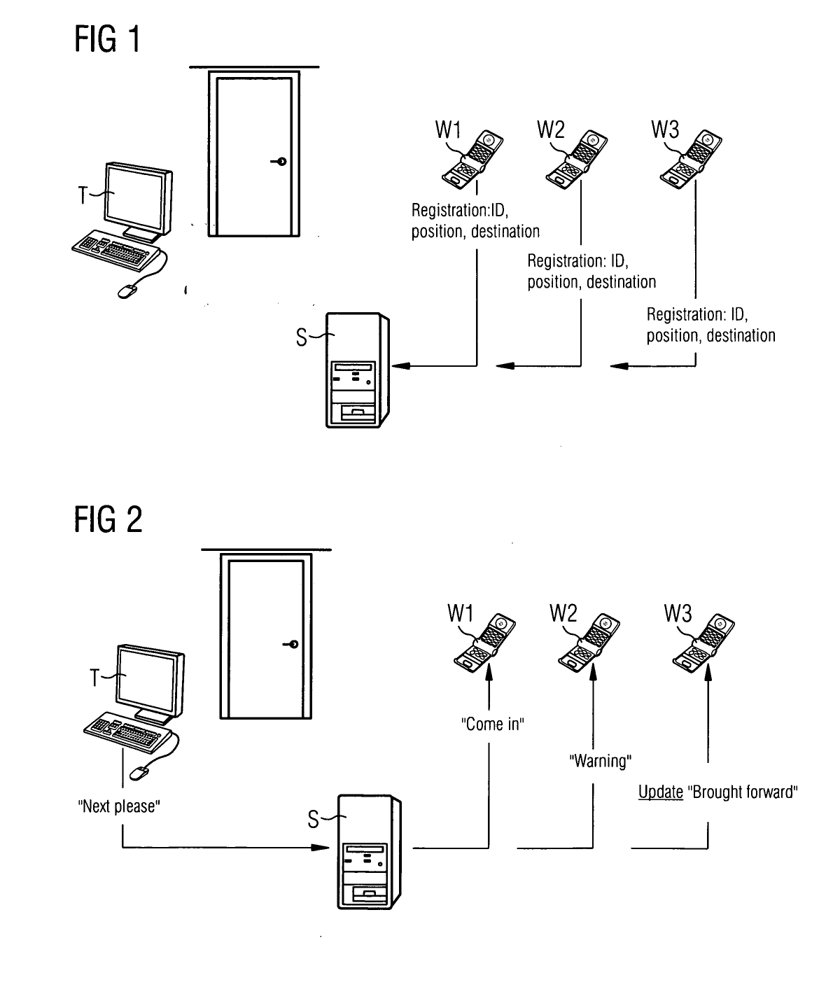

FIG. 1 shows a terminal T, a server S which is here designated as the number-drawing server, and waiting individuals W1, W2 and W3 with mobile telephones, which are shown in the form of mobile radiotelephones. In this application, a mobile telephone is to be understood as any mobile terminal device. The three waiting individuals register themselves with the number-drawing server using their mobile radiotelephones, for example via GPRS, specifying a unique ID, for example a telephone number, the queue destination, for example the residents' registration office, and the current position. In most cases it will not be necessary for the users themselves to input these data items, they can for example be automatically determined from the telephone and the current cell ID. A queue is now organized on the server, whereby only those users who are, as appropriate, physically or geographically close to the destination will be registered as waiting individuals. Alternatively, it would be possible for the numbers of those users who are prepared to make a deposit to guarantee their timely appearance also to be drawn.

FIG. 2 also shows a terminal T, a number-drawing server S and the three waiting individuals W1, . . . , W3 in the form of mobile telephones. An authorized person or an auto-mated device, as applicable, informs the number-drawing server S via the terminal T that it is the turn of the next waiting individual. The number-drawing clients which are running on the mobile telephones receive this information in the same status update that they request at regular intervals. The waiting individuals or clients, as applicable, will be informed for example by a “Come in” message that it is their turn. Correspondingly they will be informed, for example by a “Warning” message, that it will soon be their turn or, for example by a “Brought forward” message, that they have simply moved forward in the queue.

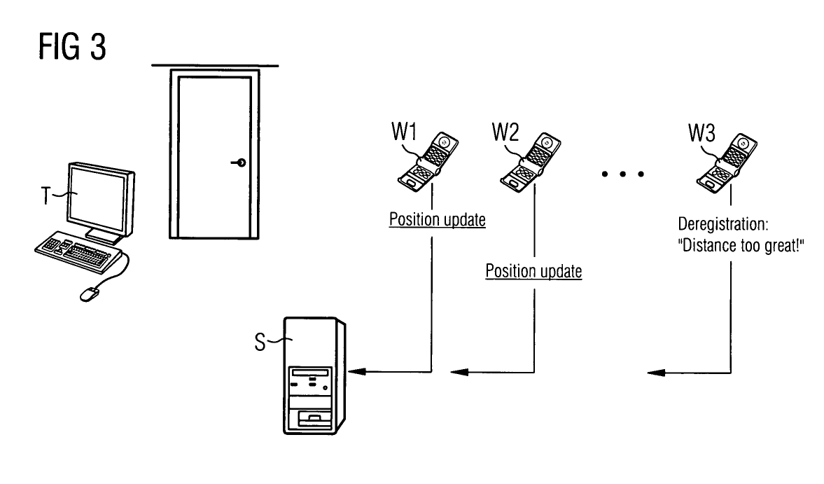

FIG. 3 shows once again a terminal T, a number-drawing server S and by way of example the individuals who are waiting, W1, . . . , W3. With each demand to the number-drawing server S for a status update, the individuals who are waiting or the clients, as applicable, also transmit their current position. If a client is further than a defined distance from the queue destination, or if for a certain time it not longer registers itself with demands for status updates, it is removed from the queue. In this way, the queue can be kept continuously up to date.

The client software, which each waiting individual requires, can be downloaded from a central web site and can be the same for all the official organizations and offices of a service provider.

Optionally, the system can also be enhanced in such a way that the queue client is linked to an additional device, which influences the priority of the individual who is waiting, i.e. his position in the queue. One example is a scenario for a hospital or a doctor, in which the client is linked to a vital parameter monitor.

In addition, there is the possibility of using the system to locate the position of individuals who are waiting, because this position is kept constantly updated. This is also relevant for a hospital scenario. If one forgoes dynamic prioritization, the digital system can be integrated with the conventional system in such a way that the numbers can be drawn both virtually and in reality. The only prerequisite for this is that the automatic system on which the numbers are drawn is also in contact with the server, so that these numbers can also be managed in the same queue.

Finally, there is also the optional possibility of a combination with a classical appointment system. Gaps in the appointments can be filled by the numbers of individuals who are waiting. In doing so, the known positions of the individuals who are waiting and those with appointments could be used, to effect early compensation for appointments which will be missed, and to react dynamically to latenesses.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method, comprising:
registering each of a plurality of individuals at a server, each individual being registered by specifying to the server via mobile telephone, a unique identification number and a queuing destination;
receiving at certain time intervals at the server, communicated via a respective mobile telephone from a plurality of the registered waiting individuals, a respective current position of each of the plurality of registered waiting individuals and sending, from the server, a current-status update; and
determining at the server, using the respective communicated current position of the waiting individual, whether a respective waiting individual is geographically within a distance where the respective waiting individual has a possibility of meeting a next available appointment time at a location, and moving other waiting individuals forward in a queue if the respective waiting individual is geographically not within the distance.

2. The method as claimed in claim 1, wherein the respective waiting individuals register with the server by specifying, at the same time, their respective current position.

3. The method as claimed in claim 1, wherein the respective waiting individuals register with the server by specifying, at the same time, data for payment of a deposit.

4. The method as claimed in claim 1, wherein the server determines, with the help of an elapsed time since a last request for a status update, whether a respective waiting individual probably no longer wishes to be given the next appointment, and moves other waiting individuals forward in the queue on the server if the elapsed time exceeds a certain value.

5. The method as claimed in claim 1, wherein vital parameters are also communicated to the server and wherein any of the waiting individuals who are in geographical proximity of the location and have critical vital parameters are moved forward in the queue on the server.

6. A computer readable medium for the server, including program segments for carrying out the method as claimed in claim 1, when executed on the server.

7. A server including a stored computer program for carrying out the method as claimed in claim 1 when executed on the server.

8. A computer readable medium including program segments for, when executed on the server, causing the server to implement the method of claim 1.

9. A method, comprising:
specifying a unique identification number and a queuing destination, via one of a plurality of respective mobile telephones, to register one of a plurality of individuals with a server via the respective mobile telephone;
communicating with the server, via the respective mobile telephone, a respective current position of the registered waiting individual and receiving, from the server, a current-status update, wherein the server then determines, using the respective communicated current position of the waiting individual, whether the respective waiting individual is geographically within a distance where the respective waiting individual has a possibility of meeting a next available appointment time at a location, and moves other waiting individuals forward in a queue if the respective waiting individual is geographically not within the distance.

10. The method as claimed in claim 9, wherein a plurality of waiting individuals register with the server by specifying, at the same time, their respective current position.

11. The method as claimed in claim 9, wherein a plurality of waiting individuals register with the server by specifying, at the same time, data for payment of a deposit.

12. The method as claimed in claim 9, wherein the server determines, with the help of an elapsed time since a last request for a status update, whether a respective waiting individual probably no longer wishes to be given the next appointment, and moves other waiting individuals forward in the queue on the server if the elapsed time exceeds a certain value.

13. The method as claimed in claim 9, wherein vital parameters are also communicated to the server and wherein any of the waiting individuals who are in geographical proximity of the location and have critical vital parameters are moved forward in the queue on the server.

14. A computer readable medium for a mobile telephone, including program segments for carrying out the method as claimed in claim 9, when executed on a computer device of the mobile telephone.

15. A computer readable medium including program segments for, when executed on a mobile phone, causing the mobile phone to implement the method of claim 9.

16. A mobile telephone including a stored computer program for carrying out the method as claimed in claim 9 when executed on the mobile telephone.

17. A mobile telephone comprising a computer readable medium including a computer program with program segments for carrying out the method as claimed in claim 9 when executed on the mobile telephone.

18. A server comprising a computer readable medium including a computer program with program segments for carrying out the method as claimed in claim 1 when executed on the server.
